(19) United States
(12) Patent Application Publication
(10) Pub. No.: US 2007/0243754 A1
(43) Pub. Date: Oct. 18, 2007

(54) Method for safely removing connecting device of peripheral equipment of computer

(76) Inventor: Min-Ru Chien, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/808,576

(22) Filed: Jun. 12, 2007

Related U.S. Application Data
(62) Division of application No. 11/012,136, filed on Dec. 16, 2004.

(51) Int. Cl. H01R 13/00

(52) U.S. Cl. 439/476.1; 29/764

(57) ABSTRACT

A method is used for safely removing a first device from a second device, e.g., removing a first connector from a matching second connector or removing an interface converter from a mother board of a computer. Thus, the loop of the strap mounted on the first device allows passage of a user's one finger so that the user's one finger directly exerts a straight outward force on the loop of the strap to easily remove the first device from the second device in a straight manner without producing deflection, thereby removing the first device from the second device easily and safely without damaging the first device or the second device during the pulling process.

### CROSS-REFERENCE

The present patent application is a divisional application of U.S. patent application Ser. No. 11/012,136 which is incorporated herein for reference.

### BACKGROUND OF INVENTION

1. Field of Invention

The present invention relates to a method for safely removing a connecting device of a peripheral equipment of a computer, and more particularly to a method for easily and safely removing a first device from a second device, e.g., removing a first connector from a matching second connector or removing an interface converter from a mother board of a computer.

2. Related Prior Art

Referring to FIG. 10, a conventional connector 8 includes a first side attached to a serial bus 80 and a second side detachably inserted into a slot 90 of a mother board 9 of a computer. However, the connector 8 only includes a smaller portion protruding from the slot 90 of the mother board 9, so that a user has to exert a larger pulling force to pull the connector 8 from the slot 90 of the mother board 9. Thus, the connector 8 cannot be directly removed from the slot 90 of the mother board 9 easily and safely so that the connector 8 and the slot 90 of the mother board 9 are easily damaged during the pulling process due to the larger pulling force.

An overhead electrical fixture and related lowering tool is disclosed in U.S. Pat. No. 5,393,245. The fixture includes a base 60 and a fixture portion 40. The base 60 is attached to a ceiling 24. A first connector 67 is disposed in an upper housing portion 61 of the base 60. A second connector 90 is connected to the fixture portion 40. The second connector 90 is inserted into a lower housing portion 70 of the base 60 so that the second connector 90 is engaged with the first connector 67. The total weight of the second connector 90 and fixture portion 40 is however too much for the engagement of the second connector 90 with the first connector 67. The second connector 90 would be disengaged from the first connector 67, and the fixture portion 40 from the base 60 without the use of a cable 78, a ring 80, a pulley 66 and a slot 82 defined in the mounting base 60. The cable 78 includes an end secured to the second connector 90 and another end connected to the ring 80. The cable 78 is wound around the pulley 66. The ring 80 can be twisted between a first position and a second position. In the first position, the ring 80 is limited outside the base 60 so that the second connector 90 is pulled by the cable 78. In the second position, the ring 80 can be moved into the base 60 through the slot 82, thus allowing the total weight of the second connector 90 and fixture portion 40 to disengage the second connector 90 from the first connector 67. This arrange however cannot be used in electronic devices since their weights are too light to disengage them from other devices. Moreover, the pulling of the strap 78 around the pulley 66 keeps the second connector 90 connected to the first connector 67. Furthermore, the structure is complicated for providing the pulley 66 in the housing 61 and making the slot 82 in the housing 61.

### SUMMARY OF THE INVENTION

The primary objective of the present invention is to provide a method for easily and safely removing a first device from a second device.

Another objective of the present invention is to provide a method that is used for removing a first device from a second device in a easier and safer manner, without damaging the first device or the second device during the pulling process.

A further objective of the present invention is to provide a safely pulling method, wherein the loop of the strap mounted on the first device allows passage of a user's one finger, so that the user's one finger directly exerts a straight outward force on the loop of the strap to easily remove the first device from the second device in a straight manner without producing deflection, thereby removing the first device from the second device easily and safely without damaging the first device or the second device during the pulling process.

A further objective of the present invention is to provide a safely pulling method, wherein the strap is foldable easily without occupying space.

In accordance with one embodiment of the present invention, a method is provided to safely remove a first device from a second device. Firstly, a strap is provided. Secondly, a first portion of the strap is connected to the first device. Finally, a second portion of the strap is made into a loop. A user can insert a finger through the loop and pull the strap to disengage the first device from the second device.

In accordance with another embodiment of the present invention, there is provided a connector including a body and a strap. The strap is extended through the body and formed with at least one loop. A user can insert a finger through the loop and pull the strap to disengage the body from another article.

In accordance with another embodiment of the present invention, there is provided an interface converter including a housing and a strap. The strap includes a first portion combined with the housing and a second portion formed with at least one loop. A user can insert a finger through the loop and pull the strap to remove the housing from another article.

Further benefits and advantages of the present invention will become apparent after a careful reading of the detailed description with appropriate reference to the accompanying drawings.

### BRIEF DESCRIPTION OF THE DRAWINGS

FIG. 1 is a side view of a connector in accordance with the preferred embodiment of the present invention;

FIG. 2 is a bottom plan view of the connector as shown in FIG. 1;

FIG. 3 is a schematic operational view of the connector as shown in FIG. 2;

FIG. 4 is a side plan view of a connector in accordance with another embodiment of the present invention;

FIG. 5 is a perspective view of a connector in accordance with another embodiment of the present invention;

FIG. 6 is a perspective view of an interface converter in accordance with another embodiment of the present invention;

FIG. 7 is an exploded perspective view of the interface converter as shown in FIG. 6;

FIG. 8 is a cross-sectional view of the interface converter shown in FIG. 6;

FIG. 9 is an exploded perspective view of a housing of an interface converter in accordance with another embodiment of the present invention; and

FIG. 10 is an exploded perspective view of a conventional connector.

### DETAILED DESCRIPTION OF INVENTION

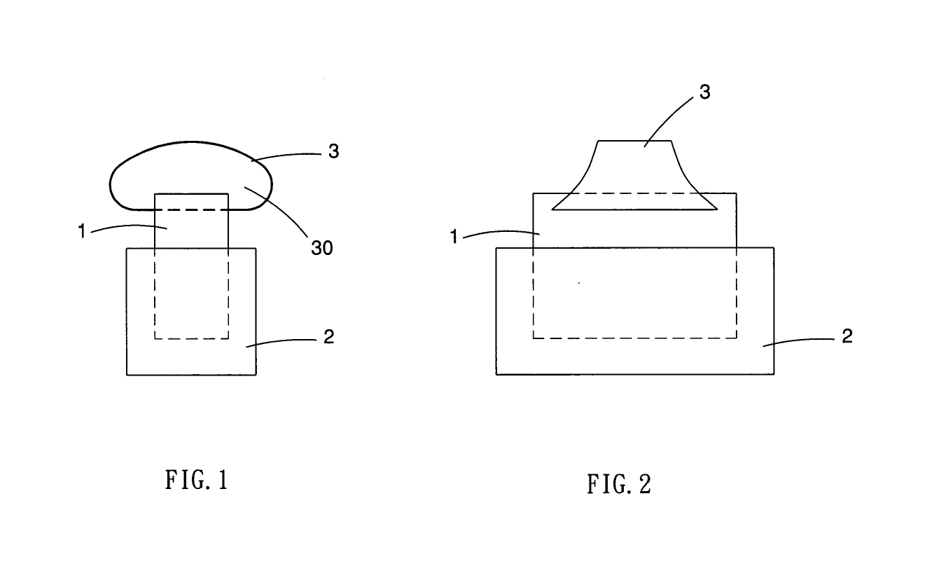

Referring to the drawings and initially to FIGS. 1 and 2, a method is used to safely remove a first device 1 from a second device 2 in accordance with the preferred embodiment of the present invention. Firstly, a strap 3 is provided. Secondly, a first portion of the strap 3 is connected to the first device 1. Finally, a second portion of the strap 3 is made into a loop 30.

Preferably, the strap 3 is made of plastic material, such as PVC or the like.

As shown in FIGS. 1 and 2, the strap 3 is attached to the first device 1 and is formed with a loop 30 protruding from the first device 1.

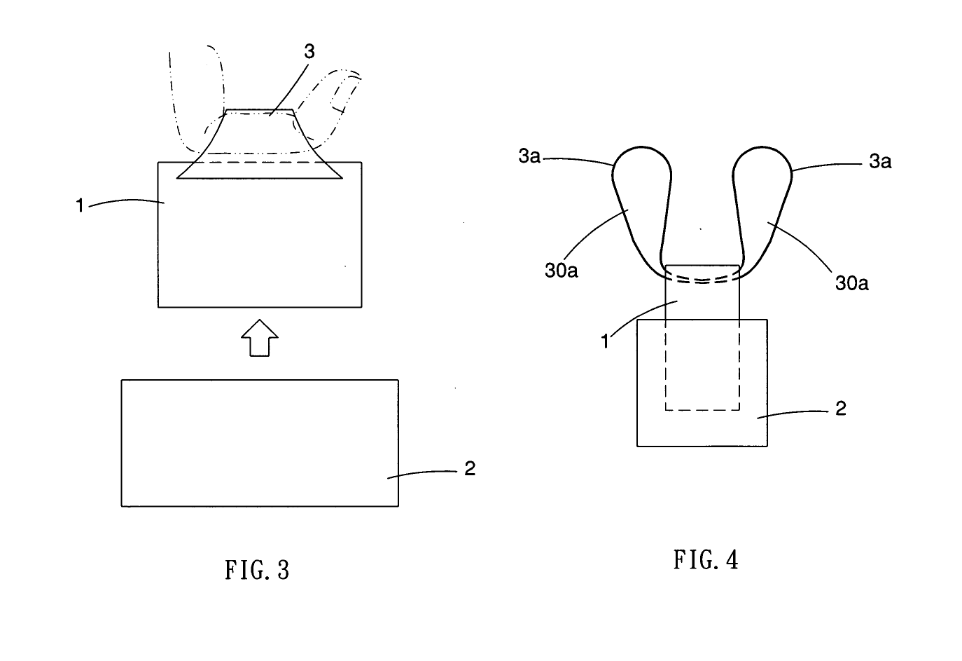

As shown in FIG. 3, the loop 30 of the strap 3 is used to receive a user's one finger so that the user's one finger directly exerts an upward force on the loop 30 of the strap 3 to easily remove the first device 1 from the second device 2 in a straight manner without producing deflection, thereby removing the first device 1 from the second device 2 safely without damaging the first device 1 or the second device 2 during the pulling process.

Referring to FIG. 4, in accordance with another embodiment of the present invention, the strap 3a includes two loops 30a to allows passage of a user's two fingers.

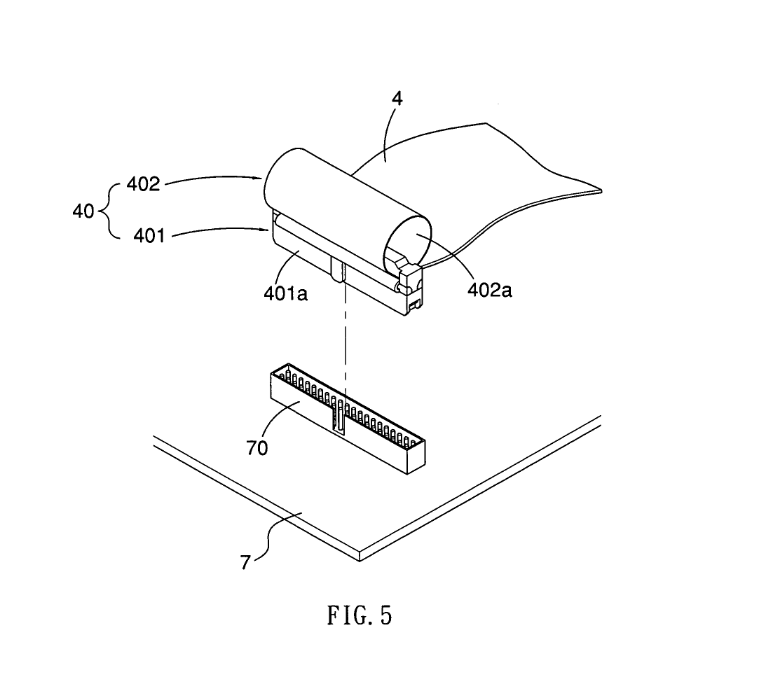

Referring to FIG. 5, in accordance with another embodiment of the present invention, the first device 1 is a first connector 40 mounted on a serial bus 4 of a computer, and the second device 2 is a second connector 70 mounted on a mother board 7 of the computer. The first connector 40 includes a body 401 attached to the serial bus 4, a strap 402 extended through the body 401 and formed with a loop 402a protruding from the body 401 to allow passage of a user's one finger, and a plug 401a mounted on the body 401 and detachably inserted into the second connector 70. Thus, the first connector 40 is safely removed from the second connector 70 by aid of the loop 402a of the strap 402.

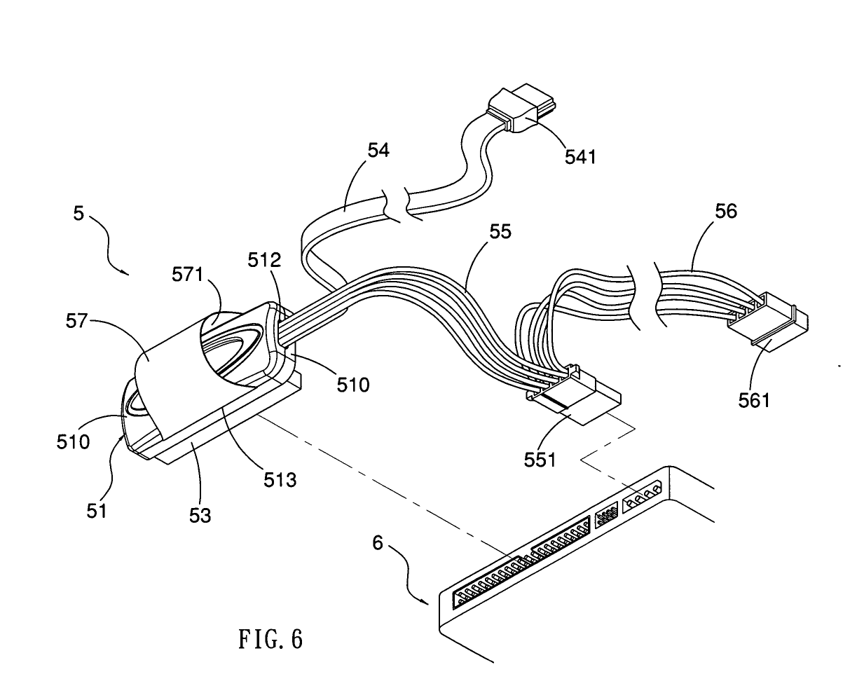

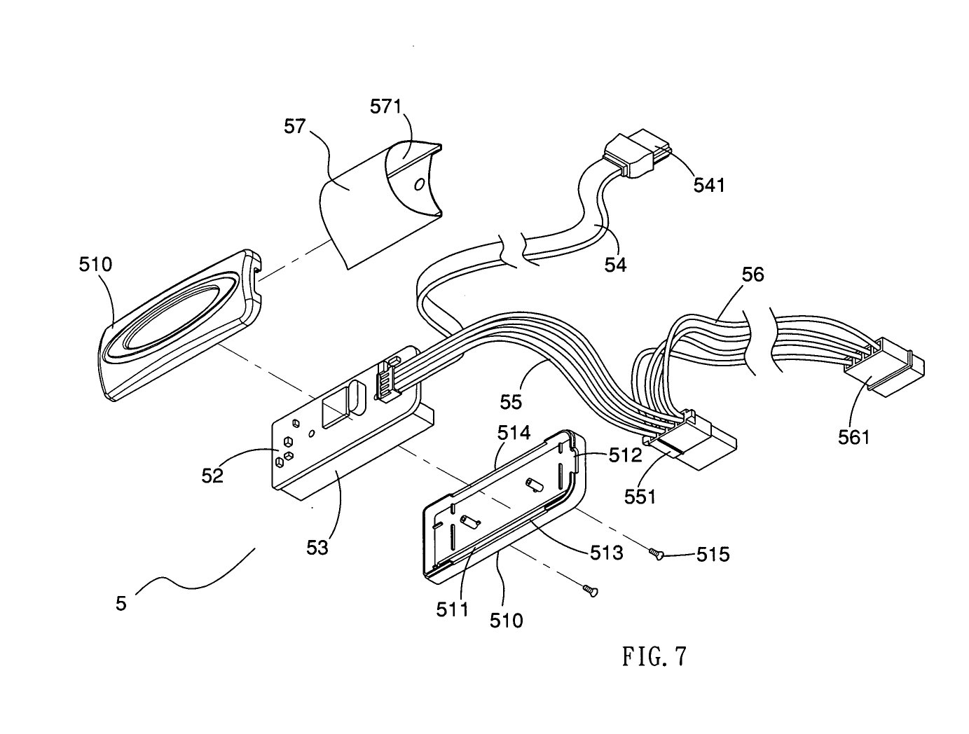

Referring to FIGS. 6-8, in accordance with another embodiment of the present invention, an interface converter 5 is used to perform an interface converting function between a first device and a second device. In the preferred embodiment of the present invention, the first device is an IDE device 6 (such as a hard disk drive or an optical disk drive), and the second device is a mother board (not shown) of a computer. In general, the IDE device 6 includes a parallel ATA interface, and the mother board includes a serial ATA interface. Thus, the interface converter 5 is used to convert the serial ATA interface of the mother board into the parallel ATA interface of the IDE device 6 so that the mother board is connected to the IDE device 6 for use with the IDE device 6.

The interface converter 5 includes a housing 51 including a back face formed with a first hole 511, a shorter side formed with a second hole 512, two opposite longer sides formed with a third hole 513 and a fourth hole 514, a circuit board 52 mounted in the housing 51, a first connector 53 mounted in the housing 51 and including a first side protruding from the first hole 511 of the housing 51 and a second side electrically connected to the circuit board 52, a connecting cable 54 including a first end extended through the second hole 512 of the housing 51 and electrically connected to the circuit board 52 and a second end electrically connected to a second connector 541, a first power cable 55 including a first end extended through the second hole 512 of the housing 51 and electrically connected to the circuit board 52 and a second end electrically connected to a third connector 551, a second power cable 56 including a first end electrically connected to the third connector 551 and a second end electrically connected to a fourth connector 561, and a strap 57 including a first portion combined with the housing 51 and a second portion extended from the housing 51 and formed with at least one loop 571 to allow passage of a user's one finger.

The housing 51 includes two casings 510 combined with each other by screws 515. The circuit board 52 is used to convert the serial ATA interface of the mother board into the parallel ATA interface of the IDE device 6. The first side of the first connector 53 of the interface converter 5 is protruded from the first hole 511 of the housing 51 and detachably inserted into the IDE device 6 to form an electrical connection. The second connector 541 is detachably inserted into the mother board of the computer to form an electrical connection. Thus, the IDE device 6 is connected to the mother board of the computer by the interface converter 5 so that the mother board of the computer is for use with the IDE device 6.

In addition, the interface converter 5 is connected to a power supply (not shown) by the fourth connector 561 to obtain an electrical power from the power supply, and the third connector 551 of the interface converter 5 is connected to the IDE device 6 so that the power supply also supplies the electrical power to the IDE device 6.

The first portion of the strap 57 is extended through the third hole 513 and the fourth hole 514 of the housing 51 so that the strap 57 is fixed to the housing 51 rigidly and stably without detachment.

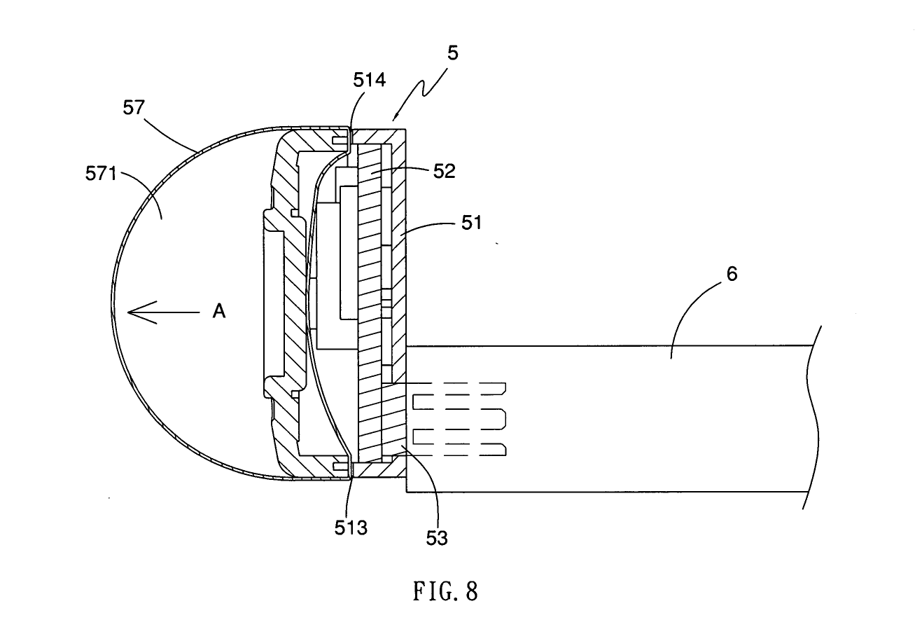

As shown in FIG. 8, the loop 571 of the strap 57 allows passage of a user's one finger, so that the user's one finger directly exerts a straight outward force (in the direction indicated by the arrow “A”) on the loop 571 of the strap 57 to easily remove the first connector 53 of the interface converter 5 from the IDE device 6 in a straight manner without producing deflection, thereby removing the first connector 53 of the interface converter 5 from the IDE device 6 safely without damaging the first connector 53 of the interface converter 5 or the IDE device 6 during the pulling process.

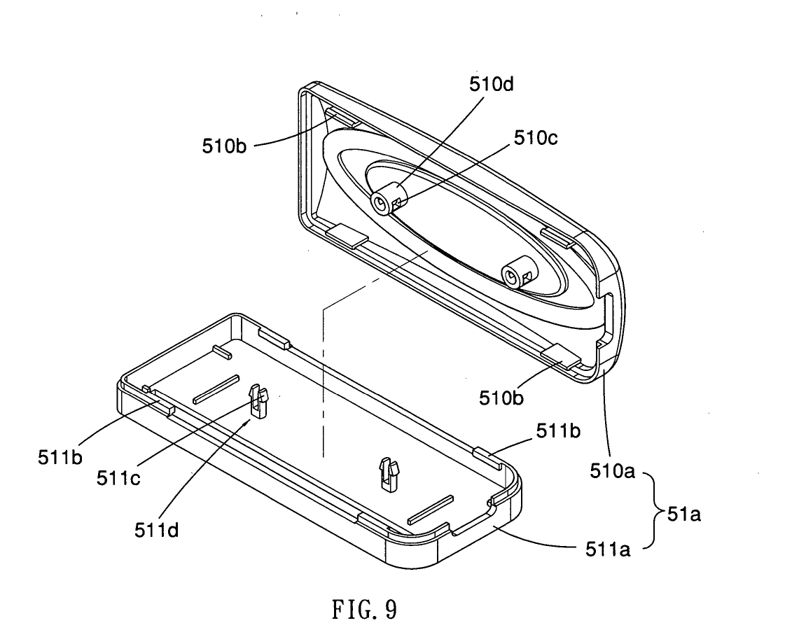

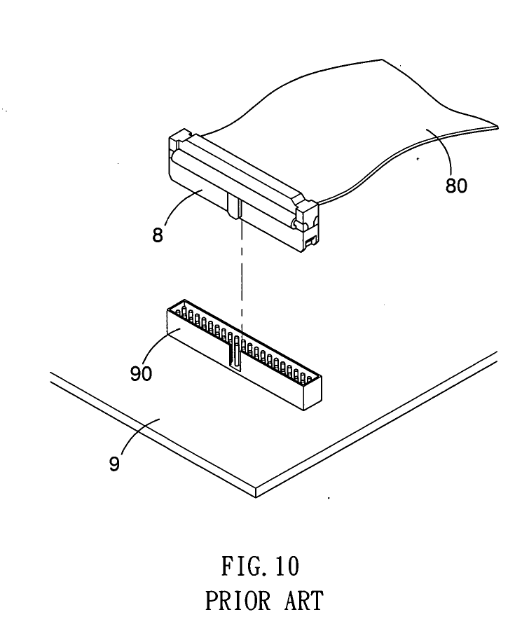

Referring to FIG. 9, in accordance with another embodiment of the present invention, the housing 51a includes a first casing 510a and a second casing 511a combined with each other in a snapping manner.

The second casing 511a includes a peripheral wall provided with a plurality of inverted L-shaped locking blocks 511b, and the first casing 510a includes a peripheral wall provided with a plurality of L-shaped locking hooks 510b each snapped on a respective one of the locking blocks 511b of the second casing 511a, so that the first casing 510a and the second casing 511a are combined with each other.

In addition, the first casing 510a includes a side provided with a plurality of fixing barrels 510d each including a peripheral wall formed with two radially opposite snapping holes 510c, and the second casing 511a includes a side provided with a plurality of forked fixing posts 511d each secured in a respective one of the fixing barrels 510d of the first casing 510a and each formed with two opposite barbs 511c each snapped into and locked in a respective one of the snapping holes 510c of the respective fixing barrel 510d of the first casing 510a so that the first casing 510a and the second casing 511a are combined with each other rigidly and stably.

Accordingly, the method of the present invention is used for removing a first device from a second device in a easier and safer manner, without damaging the first device or the second device during the pulling process. In addition, the loop of the strap mounted on the first device allows passage of a user's one finger, so that the user's one finger directly exerts a straight outward force on the loop of the strap to easily remove the first device from the second device in a straight manner without producing deflection, thereby removing the first device from the second device easily and safely without damaging the first device or the second device during the pulling process.

Although the invention includes been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A method for safely removing a first device from a second device, the method comprising the steps of:
providing a soft strap;
combining a first portion of the soft strap with the first device; and
making a second portion of the strap into a loop so that a user can insert a finger through the loop and pull the strap to disengage the first device from the second device without the help from the weight of the first device.

2. A connector comprising:
a body; and
a strap extended through the body and formed with at least one loop outside the body so that a user can insert a finger through the loop and pull the strap to displace the body without the help from the weight of the body.

3. The connector in accordance with claim 2 further comprising a plug mounted on the main body.

4. The connector in accordance with claim 2 wherein the strap comprises two loops used to receive a user's two fingers.

5. An interface converter comprising:
a housing; and
a strap comprising a first portion connected to the housing and a second portion extended outward from the housing and formed with at least one loop so that the user can insert a finger through the loop and pull the strap to displace the housing without the help from the weight of the housing.
